(19) United States
(12) Patent Application Publication
(10) Pub. No.: US 2009/0056464 A1
(43) Pub. Date: Mar. 5, 2009

(54) PIRANI PRESSURE GAUGE

(75) Inventors: Waleed Ahmed Qader, East Sussex (GB); Alan Edward Holme, East Sussex (GB)

Correspondence Address: Edwards Vacuum, Inc., 55 MADISON AVENUE, Suite 400, MORRISTOWN, NJ, 07960, US

(73) Assignee: THE BOC GROUP PLC, Surrey (GB)

(21) Appl. No.: 11/658,485

(22) PCT Filed: Jul. 12, 2005
(86) PCT No.: PCT/GB2005/002722

§ 371 Date: Oct. 17, 2008

(30) Foreign Application Priority Data
Jul. 26, 2004 (US) 0416633.6

(51) Int. Cl. G01L 21/12

(52) U.S. Cl. 73/755

(57) ABSTRACT

A Pirani pressure gauge comprises a heated, coiled sensing element formed from an alloy comprising platinum and iridium, for example, 90/10 Pt/Ir. This enables the gauge to be deployed in a corrosive environment and reliably measure pressures as low as 10⁻⁴ mbar over a prolonged period of time.

This invention relates to a pressure gauge.

One well-known type of pressure gauge is a Pirani gauge. Such gauges are used for measuring the pressure of a gas by means of a heated filament of which the temperature is measured in terms of its electrical resistance. The rate at which the filament loses heat to its surroundings, is a function of the gas pressure, and hence may be used to permit the gauge to measure vacuum.

In the Pirani gauge, the filament is in one arm of a Wheatstone bridge circuit. The gauge may be operated in either a constant temperature or a constant voltage mode. In the former mode, the power supplied to keep the filament at a constant temperature varies with changes in gas pressure, and hence this power acts as a measure of the degree of vacuum. In the latter mode, the variation with gas pressure of the electrical imbalance of the bridge acts as a measure of the degree of vacuum.

The filament of a Pirani gauge typically comprises a wire carried on a suitable support to minimise loss of heat from the wire by conduction. For example, the BOC Edwards APG-MP Pirani gauge contains a filament formed from a platinum/rhodium alloy. The use of materials such as platinum or Pt/Rh alloy for the wire enables the gauge to measure pressures down to 10⁻³ mbar in corrosive environments typically encountered in semiconductor processing applications.

Recently, there has been an increasing demand to measure pressures as low as 10⁻⁴ mbar in such corrosive environments. In order to increase the range of a Pirani gauge, it is known to increase the length of the filament by coiling, thereby reducing the effect of heat loss through the filament support whilst minimising the increase in the size of the gauge. For example, the BOC Edwards APG-L Pirani gauge contains a coiled filament formed from gold-coated tungsten, which is able to measure pressures down to 10⁻⁴ mbar. However, prolonged exposure of such a filament to a corrosive medium, such as fluorine, dramatically decreases the effective lifetime of the gauge. Replacing the filament with a filament formed from platinum or a platinum/rhodium alloy is impractical, as wires formed from these materials cannot be coiled tightly enough to attain the required filament length within an acceptable gauge size. As a result, it is usual for relatively expensive capacitance manometer gauges to be used for this purpose.

In order to address this problem, the present invention provides a thermal conductivity pressure gauge comprising a heated, coiled filament formed from an alloy comprising platinum and iridium, the amount of platinum in the alloy being at least 70%, preferably approximately 90% platinum and 10% iridium.

In contrast to filaments formed from Pt or a Pt/Rh alloy, the mechanical properties of the Pt/Ir alloy enable the wire to be coiled relatively tightly, whilst the thermal properties of the alloy enable the gauge to measure pressure down to 10⁻⁴ mbar. In addition, the chemical properties of the alloy provide superior corrosion resistance in comparison to conventional gauges in which the filament is formed from tungsten or gold-coated tungsten.

As a result, the present invention can provide a relatively low cost pressure gauge that is suitable for use in semiconductor manufacturing applications where pressures as low as 10⁻⁴ mbar need to be measured in a corrosive environment, and which has superior reliability in comparison to conventional Pirani gauges typically provided for this purpose.

By way of example, an embodiment of the invention will now be further described with reference to the following figures in which:

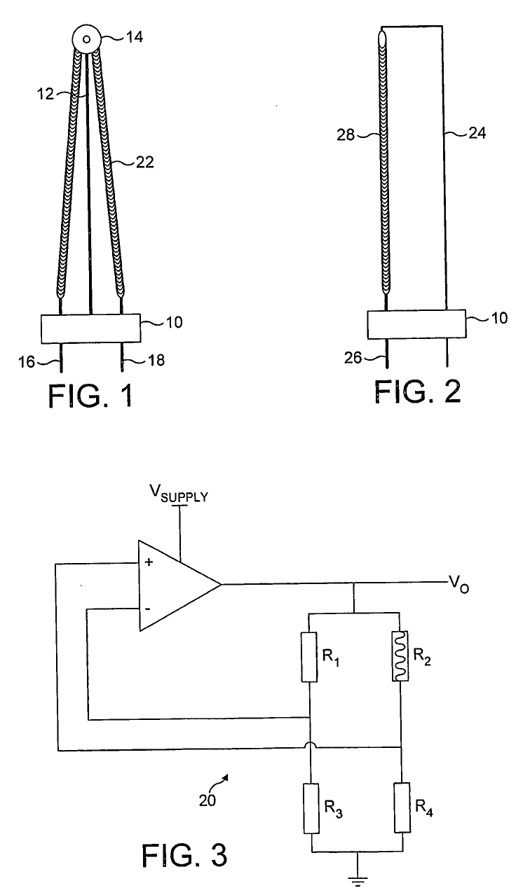

FIG. 1 illustrates a view of one embodiment of a head of a Pirani gauge;

FIG. 2 illustrates a view of a second embodiment of a head of a Pirani gauge;

FIG. 3 illustrates a control circuit incorporating the filament of the gauge head; and

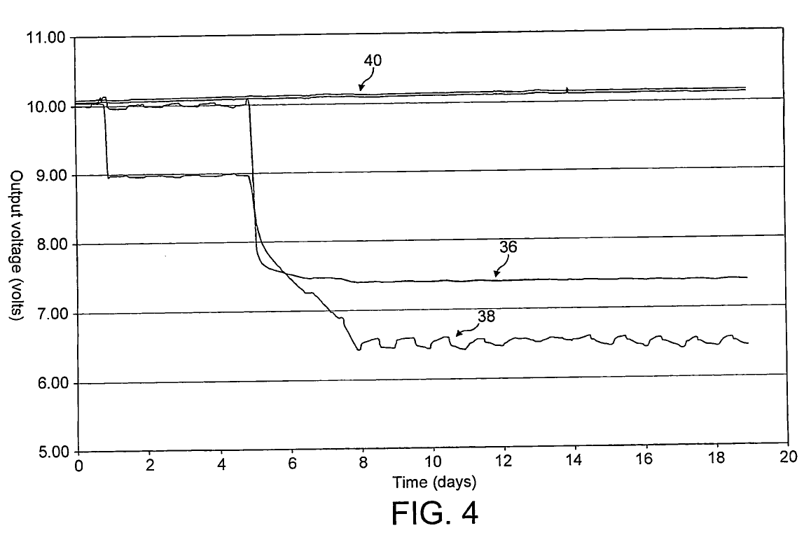

FIG. 4 illustrates the variation with time of the reading from a number of different gauges located in a fluorine environment.

With reference initially to FIG. 1, a first embodiment of a head of a Pirani gauge comprises a corrosion resistant, electrically insulating base 10, formed for example, from glass or ceramic, which forms part of an envelope (not shown) adapted to communicate with the environment to be monitored. Examples of such an environment include an enclosure under evacuation or maintained at a low pressure, or the exhaust of a vacuum pump.

One end of a corrosion resistant, rod 12 electrically insulated from the filament is embedded in the base 10 made from an insulating material. An electrically insulating bobbin 14 is attached to the other end of the rod 12. Two electrically conducting metal pins 16, 18 are also embedded in the base 10. The lower (as shown) ends of pins 16, 18 provide connecting pins to a Wheatstone bridge circuit 20, shown in FIG. 3.

A filament 22 is spot welded to the upper ends of the pins 16, 18. The filament 22 is formed from a single length of coiled wire made of an alloy of platinum and iridium. In this embodiment, the filament is made of 90/10 Pt/Ir alloy, containing 90% Pt and 10% Ir (by weight). The filament 22 passes over the bobbin 14, preferably within a circumferential groove formed in the bobbin, such that the filament 22 is retained under slight tension between the pins 16, 18 in a “V” configuration.

In another embodiment shown in FIG. 2, the Pirani gauge head comprises a similar electrically insulating base 10 to the first embodiment. A corrosion resistant, electrically conducting rod 24 is embedded in the base 10. The lower (as shown) end of the rod 24 provides a first connecting pin for the Wheatstone bridge circuit 20. The upper end of the rod 24 has an “L” shaped portion relative to the main portion of the rod 24. Similar to the first embodiment, a metal pin 26 is also embedded in the base 10, the lower (as shown) end of the pin 26 providing a second connecting pin to the Wheatstone bridge circuit 20. A filament 28 is spot welded to the upper end of the pin 26 and the upper end of the rod 24. Similar to the first embodiment, the filament 28 is formed from a single length of coiled wire made of an alloy of platinum and iridium. In this embodiment also, the filament is made of 90/10 PI/Ir alloy.

With reference to FIG. 3, the Wheatstone bridge circuit 20 has the usual four resistances Ri, R2, R3 and R₄, each provided on a respective arm of the bridge circuit 20, and where Ri, R₃ and R₄ are fixed resistances and R₂ is the resistance of the filament of the Pirani gauge. The balanced condition of the bridge circuit 20 is given by the equation R₂=Ri·R4/R₃—

In use, the operational amplifier supplies the bridge with voltage ensuring that the bridge remains balanced at all time. In this case, the hot resistance of the filament remains constant. This is governed by the constant resistance of the other arms of the bridge. As the pressure in the gauge head increases, for example, the heat loss from the filament increases. The operational amplifier will increase the voltage to the bridge to ensure its balance. In this mode of operation, the supplied voltage will be used as a pressure indicator. Calibration of the gauge will allow conversion of the supply voltage to pressure.

In both of the embodiments described above, the filament of the gauge is formed from an alloy of platinum and iridium, the preferred composition being 90/10 Pt/Ir, although different percentages, by weight, of Pt and Ir may be provided. The mechanical properties of this alloy enable a wire to be coiled sufficiently tightly to enable the filament to replace tungsten or gold-coated tungsten filaments typically used to measure pressures down to 10⁻⁴ mbar, whilst the chemical properties of the alloy provide improved corrosion resistance in comparison to conventional filaments formed from W or Au-coated W.

For example, FIG. 4 is a graph showing the results of tests performed using five Pirani gauges located for around 19 days within an atmosphere containing 20% fluorine at atmospheric pressure. Three of these gauges were gauges according to the second embodiment, as illustrated in FIG. 2, each having a 90/10 Pt/Ir filament. The fourth gauge was similar to the first three gauges, except that the filament comprised a Au-coated W filament, and the fifth gauge was again similar to the first three gauges, but with the exception here that the filament comprised a w filament.

The results of the test indicated that the readings from the gauges containing the conventional W or Au-coated W filaments, as indicated by arrows 36 and 38 respectively in FIG. 4, dropped by at least 2 volts after 5 days of exposure, due to filament degradation by the fluorine atmosphere. In contrast, the readings from the three gauges containing Pt/Ir filaments, indicated by the arrow 40, remained substantially constant over the entire length of the test, indicating the superior corrosion resistance of the Pt/Ir alloy.

1. A thermal conductivity pressure gauge comprising a heated, coiled filament formed from an alloy comprising platinum and iridium, the amount of platinum in the alloy being at least 70%.

2. The gauge according to claim 1 wherein the alloy comprises approximately 90% platinum and 10% iridium.

3. The gauge according to claim 1 comprising a circuit for supplying an electrical current to the filament to heat the filament.

4. The gauge according to claim 1 wherein the filament is formed in a non-linear configuration.

5. The gauge according to claim 4 wherein the filament has a substantially V-shape.

6. The gauge according to claim 1 wherein the filament forms one arm of an electrical bridge arranged to produce an electrical output signal representative of gas pressure within the gauge.
